(19) United States
(12) Patent Application Publication
(10) Pub. No.: US 2006/0274906 A1
(43) Pub. Date: Dec. 7, 2006

(54) Acoustic sensor with combined frequency ranges

(76) Inventors: Ying Jia, Beijing (CN); Xiaoying Janet He, Beijing (CN); Robert J. Meinschein, Tigard, OR (US)

Correspondence Address: INTEL CORPORATION, P.O. BOX 5326, SANTA CLARA, CA, 95056-5326, US

(21) Appl. No.: 11/145,769

(22) Filed: Jun. 6, 2005

(51) Int. Cl. H04B 1/00; H04R 3/00

(52) U.S. Cl. 381/119; 381/122

(57) ABSTRACT

A hybrid acoustic sensor can include a first acoustic sensor, a second acoustic sensor, and a mixer. The first acoustic sensor can generate a first signal to represent acoustic data in a first bandwidth around a first center frequency. The second acoustic sensor can be co-located with the first acoustic sensor, and can generate a second signal to represent the acoustic data in a second bandwidth around a second center frequency. A lower bound of the first bandwidth can be at a lower frequency than a lower bound of the second bandwidth, and a higher bound of the second bandwidth can be at a higher frequency than a higher bound of the first bandwidth. The mixer can combine the first signal and the second signal into a third signal to represent the acoustic data in a third bandwidth from the lower frequency to the higher frequency.

### FIELD OF THE INVENTION

The present invention relates to the field of acoustic sensors. More specifically, the present invention relates to an acoustic sensor with combined frequency ranges.

### BACKGROUND

Acoustic data can be used in computers and consumer electronics for a variety of purposes. For example, video conferencing and virtual meeting technology often include microphones to capture audible acoustic data, such as the voices of the participants, so that the audible data can be provided along with video data and/or graphical data to the other participants. Audible acoustic data can also be used to record sounds such as speech and music, capture dictation and convert it to text, detect and track the location of a speaker in a room in order to automatically focus a camera on that individual, and countless other applications.

In addition to audible acoustic data, ultrasonic acoustic data can also have a number of uses. An ultrasonic (US) pen is one example. Some US pens can be used like a regular pen to write on a surface, such as a piece of paper or a whiteboard. At the same time however, the motion of the pen can be tracked using a combination of acoustics and electronics to capture the pen's motion.

US pen technology has many applications. For example, as a user writes on a surface, an image of the writing can be captured and shown on a computer display. This can be particularly useful in video conferences and virtual meetings. For instance, as a speaker writes notes on a whiteboard during a meeting, the writing can be displayed on computer screens for participants in the room as well as those located remotely.

As another example, in addition to capturing an image of what is written on a surface, a US pen can also be used to move a mouse pointer in a graphical user interface. This can also be particularly useful during video conferences and virtual meetings. For instance, presentations are commonly assembled on a computer and then projected onto a wall or screen, as well as provided to remote viewers through network connections. With a US pen, a person can interact with the presentation directly from the image projected onto the screen. That is, the person can move the pen over the screen's surface, and the system can capture the motion of the pen and move an image of a mouse pointer on the screen, as well as the displays of the remote viewers, to track the pen's motion. These are just two examples of the many ways in which US pen technology can be used.

### BRIEF DESCRIPTION OF DRAWINGS

Examples of the present invention are illustrated in the accompanying drawings. The accompanying drawings, however, do not limit the scope of the present invention. Similar references in the drawings indicate similar elements.

FIG. 1 illustrates one embodiment of an acoustic data system.

FIG. 2 illustrates one embodiment of a hybrid sensor.

FIG. 3 illustrates one embodiment of how a hybrid sensor can be collocated.

FIG. 4 illustrates one embodiment of frequency ranges that can be combined by a hybrid sensor.

FIG. 5 illustrates one embodiment of a host device.

FIG. 6 illustrates one embodiment of a hybrid sensor process.

FIG. 7 illustrates one embodiment of a hardware system that can perform various functions of the present invention.

FIG. 8 illustrates one embodiment of a machine readable medium to store instructions that can implement various functions of the present invention.

### DETAILED DESCRIPTION OF THE INVENTION

In the following description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and circuits have not been described in detail.

Parts of the description will be presented using terminology commonly employed by those skilled in the art to convey the substance of their work to others skilled in the art. Also, parts of the description will be presented in terms of operations performed through the execution of programming instructions. It is well understood by those skilled in the art that these operations often take the form of electrical, magnetic, or optical signals capable of being stored, transferred, combined, and otherwise manipulated through, for instance, electrical components.

Various operations will be described as multiple discrete steps performed in turn in a manner that is helpful for understanding the present invention. However, the order of description should not be construed as to imply that these operations are necessarily performed in the order they are presented, nor even order dependent. Lastly, repeated usage of the phrase “in one embodiment” does not necessarily refer to the same embodiment, although it may.

Since both audible and ultrasonic acoustic data have so many useful applications, it would be beneficial to have an acoustic sensor that can receive both types of acoustic data. The frequency range of audible sound tends to be from about zero to 20 KHz. Different ultrasonic applications, tend to use different ranges of ultrasonic frequency. For instance, one brand of ultrasonic pen may use a signal in the 40 KHz to 50 KHz range, and another brand may use a signal in the 80 KHz to 90 KHz range. The frequency range of ultrasonic sound is generally considered to be about 40 KHz to 100 KHz. So, an ultrasonic sensor that can support a variety of ultrasonic applications would likely need to be able to detect the entire ultrasonic range from 40 KHz to 100 KHz. Adding the audible range to the ultrasonic range to support both audible and ultrasonic applications, and the combined range of useful acoustic data may extend from zero to 100 KHz.

Acoustic sensors with 100 KHz of bandwidth may exist, but these broadband sensors tend to be excessively expensive for use in the competitive computer and consumer electronics market. Furthermore, many applications of acoustic data use arrays of multiple sensors, making the use of broadband sensors even more cost prohibitive.

Embodiments of the present invention can combine the bandwidths of less expensive sensors to provide a hybrid sensor that can be considerably less expensive than existing broadband sensors, while providing the same or similar total effective bandwidth. Although embodiments of the present invention will be primarily described in the context of a hybrid sensor for combining the ultrasonic and audible frequency ranges, other embodiments of the present invention can similarly combine virtually any number of virtually any frequency ranges into a hybrid sensor.

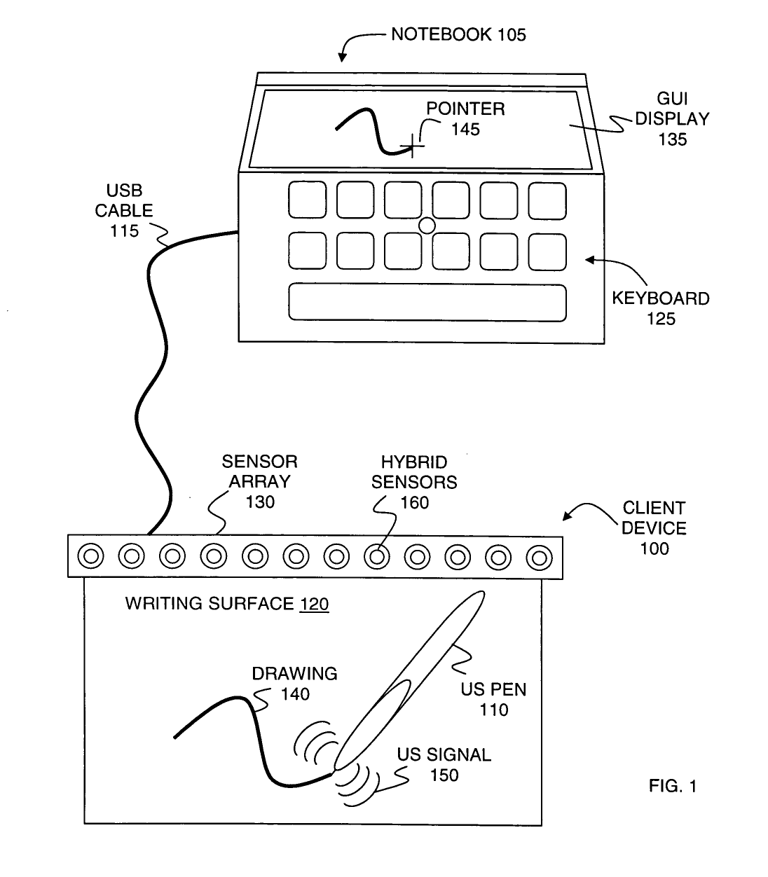

FIG. 1 illustrates one example of an acoustic data system in which embodiments of the present invention can be used. A client device 100 may include a US pen 110, a writing surface 120, and a sensor array 130. US pen 110 can be used to make a drawing 140 on surface 120. While pen 110 is in contact with surface 120, the pen can also give off an ultrasonic signal 150 near the writing end of the pen.

Sensor array 130 can include a number of hybrid sensors 160 positioned along an edge of writing surface 120. Each sensor 160 may be able to receive ultrasonic signal 150. The signal that is captured by each sensor 160 can comprise a separate channel of acoustic data. The illustrated embodiment includes 12 sensors 160, which means the illustrated embodiment can capture up to 12 channels of acoustic data. Each channel of data can be converted to a series of data samples and the samples can be synchronously interleaved. That is, a data sample from channel 1 can be followed by a data sample from channel 2, which can be followed by a data sample from channel 3, and so on up to channel 12. The pattern can repeat, interleaving data samples from channels 1 through 12 at some periodic rate.

The 12 channels of data can be provided to a host device through a communications medium. In the illustrated embodiment, the host device is a notebook computer 105 and the communications medium is a universal serial bus (USB) cable 115. Notebook 105 may include a keyboard 125 and a display 135 for displaying a graphical user interface (GUI). The 12 channels of data can be used by notebook 105 to control the position of a pointer 145 in display 135 and/or capture and display drawing 140.

For instance, since the distance from pen 110 to any pair of sensors 160 is likely to be different, the amount of time that signal 150 takes to reach the pair of sensors is likely to be different. This propagation delay between two channels of acoustic data, along with the speed of sound and the relative locations of the two sensors, can be used to calculate a position of pen 110. In other words, various algorithms can be used to triangulate a position of the pen and track the pen's motion as the position changes over time.

Since the sensors 160 are hybrid sensors, they may also be able to receive audible acoustic data. For instance, sensor array 130 may be able to capture a user's voice. With 12 channels of data, a variety of applications could use the data for noise cancellation, speaker tracking, and the like.

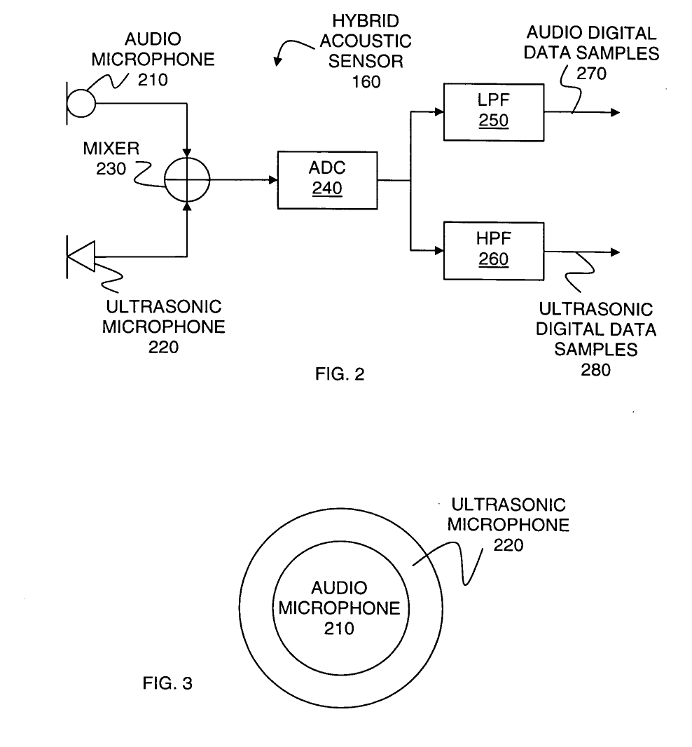

FIG. 2 illustrates one example of a hybrid acoustic sensor that could be used for sensors 160 in FIG. 1. Hybrid sensor 160 can include an audio microphone 210 and an ultrasonic microphone 220. Each microphone can capture acoustic data in a different frequency range and convert it to an analog electric signal. An analog mixer 230 can combine the signals and provide the combined analog signal to a shared analog-to-digital converter (ADC) 240. ADC 240 can sample the combined analog signal at a particular sampling rate and convert it to a stream of digital samples.

In the illustrated example, hybrid sensor 160 also includes two digital filters, a low pass filter 250 and a high pass filter 260. Low pass filter 250 can filter out data in the stream of digital samples corresponding to higher frequencies, and provide a stream of digital data samples 270 representing the audible data. High pass filter 260 can do just the opposite to provide a stream of digital data samples 280 representing the ultrasonic data.

Hybrid sensor 160 can be considerably less expensive than a single, broadband sensor capable of detecting both the audible and ultrasonic acoustic ranges because the cost of an acoustic sensor tends to increase dramatically at higher bandwidths. In other words, the cost of a microphone with a 20 KHz bandwidth, a microphone with a 60 KHz bandwidth, plus an analog mixer can be considerable less than a 100 KHz bandwidth microphone.

As shown in FIG. 3, the two microphones can be co-located so that they share one position in an array of sensors. For example, audio microphone 210 may have a circular form factor, and ultrasonic microphone 220 may have an annular form factor that surrounds audio microphone 210. With the sensors collocated, the data from both sensors may be treated as a single channel of data from one location, as if the combined data were coming from a single sensor.

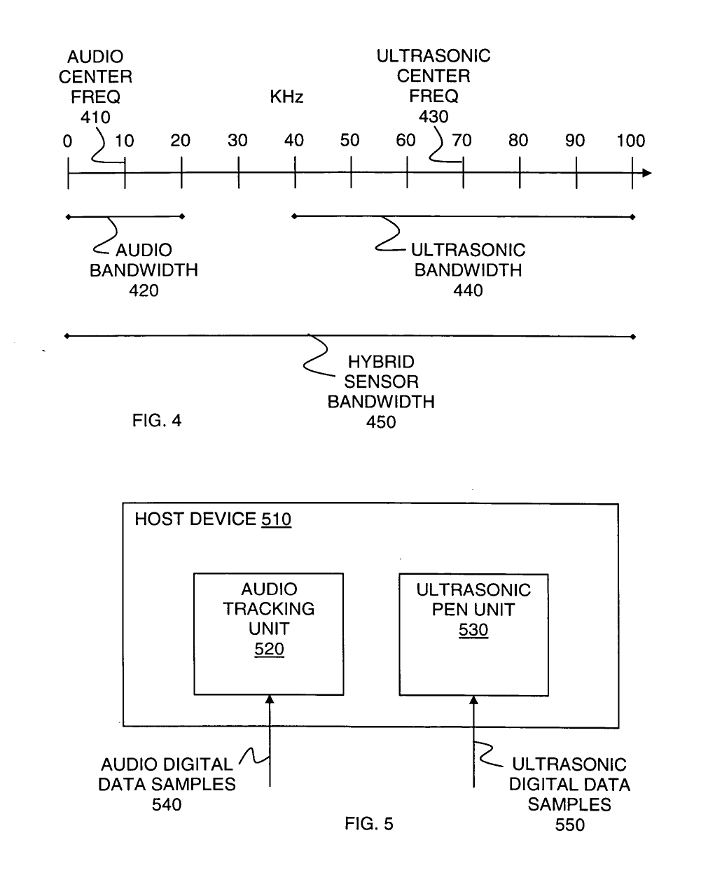

FIG. 4 illustrates one example of the frequency ranges that could be captured by the hybrid sensor of FIG. 2. Audio microphone 210 from FIG. 2 may have a center frequency 410 at 10 KHz, and a 20 KHz bandwidth 420. Ultrasonic microphone 220 from FIG. 2 may have a center frequency 430 at 70 KHz, and a 60 KHz bandwidth 440. By mixing signals captured from the two microphones, the hybrid sensor can have an effective 100 KHz bandwidth 450 extending from the lower bound of bandwidth 420 to the upper bound of the bandwidth 440.

Frequencies between 20 KHz and 40 KHz may not be captured by the hybrid sensor in this particular example. But, data in that frequency range may not be needed by the set of applications that use this particular hybrid sensor. For example, as shown in FIG. 5, a host device 510 may include an audio tracking unit 520 that uses audio digital data samples 540 in the 0 to 20 KHz range, and an ultrasonic pen unit 530 that uses ultrasonic digital data samples 550 in the 40 KHz to 100 KHz range. For a different set of applications, a combined sensor could be designed to support the needed frequency ranges.

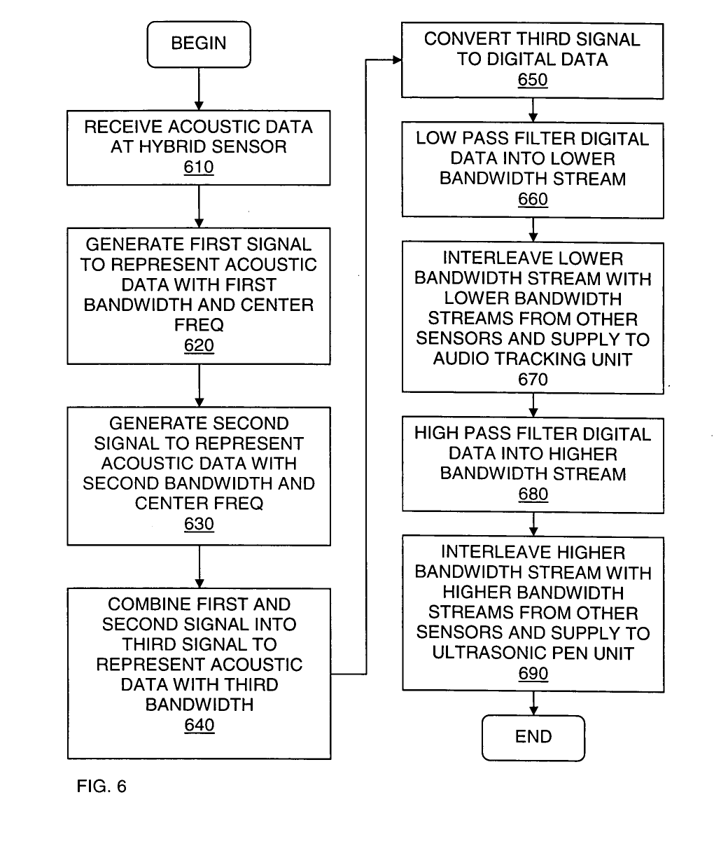

FIG. 6 illustrates an example of a process that could be used by one embodiment of a hybrid sensor, such as sensor 160. At 610, the hybrid sensor can receive acoustic data. At 620, the hybrid sensor can generate a first signal to represent the acoustic data in a first bandwidth, around a first center frequency. At 630, the hybrid sensor can generate a second signal to represent the acoustic data in a second bandwidth, around a second center frequency. At 640, the sensor can combine the first and second signals into a third signal to represent the acoustic data in a third bandwidth extending from a frequency at a lower bound of the first bandwidth to a frequency at a higher bound of the second bandwidth. Then, at 650, the hybrid sensor can convert the third signal into a stream of digital data samples representing the acoustic data in the third bandwidth.

At 660, the stream of data samples can be low-passed filtered into a stream of digital data samples representing a bandwidth of acoustic data at lower frequencies. At 670, the lower frequency data can then be interleaved with similar lower frequency data streams from other hybrid sensors in a sensor array, and supplied to an audio tracking unit in a host device.

At 680, the stream of data samples can be high-passed filtered into a stream of digital data samples representing a bandwidth of acoustic data at higher frequencies. At 690, the higher frequency data can then be interleaved with similar higher frequency data streams from the other hybrid sensors in the sensor array, and supplied to an ultrasonic pen unit in the host device.

FIGS. 1-6 illustrate a number of implementation specific details. Any number of technologies could be used to implement the various components of a hybrid sensor. For example, in one embodiment, one or more of the components can be implemented using micro-electrical-mechanical-system (MEMS) technology. Other embodiments may not include all the illustrated elements, may arrange the elements differently, may combine one or more of the elements, may include additional elements, and the like.

For example, in FIG. 1, the sensors in the sensor array could be arranged differently along one or more sides of the writing surface, a wide variety of computer and/or consumer electronics devices could be used for the host device, and any number of communications mediums could be used to connect the client and host devices, including a serial cable, a wireless connection, an optical connection, or an internal network connection where the client and host are components within a larger device.

Similarly, in FIG. 2, the filtering could be done further upstream in'the system. For example, the combined analog signal, or the stream of data samples representing the combined analog signal, may be provided to the host device, and the host device may filter out different portions of the data. Other embodiments can similarly include more microphones than those shown in FIG. 2, to capture additional frequency ranges, as well as additional filters, to isolate different portions of the combined frequency ranges. For example, one embodiment may use three sensors, one for 0 to 30 KHz, one for 30 KHz to 60 KHz, and one for 60 KHz to 90 KHz, for a combined effective bandwidth of 90 KHz. Another embodiment may include three filters, a low pass filter for audible data, a band pass filter for ultrasonic data between 40 KHz and 50 KHz, and another band pass filter for ultrasonic data between 80 KHz and 90 KHz.

Other examples of FIG. 3 could use an annular shape for the audio microphone and an embedded circular shape for the ultrasonic microphone. In still other examples, the microphones could take virtually any shapes that allow them to be collocated.

In FIG. 5, any number of technologies could be used to implement the audio tracking unit and the ultrasonic pen unit. Other examples of FIG. 5 could include any number of a wide variety of applications and technologies that can use acoustic data.

Other examples of FIG. 6 could divide various functions between a client device and a host device. For example, in one embodiment, a client device may perform functions 610 through 650 to generate a streamed of combined digital data, and interleave the steams of combined data from multiple channels of sensors before sending the interleaved data to a host device. In which case, the host device may filter various frequency ranges of data from the interleaved stream of combined digital data.

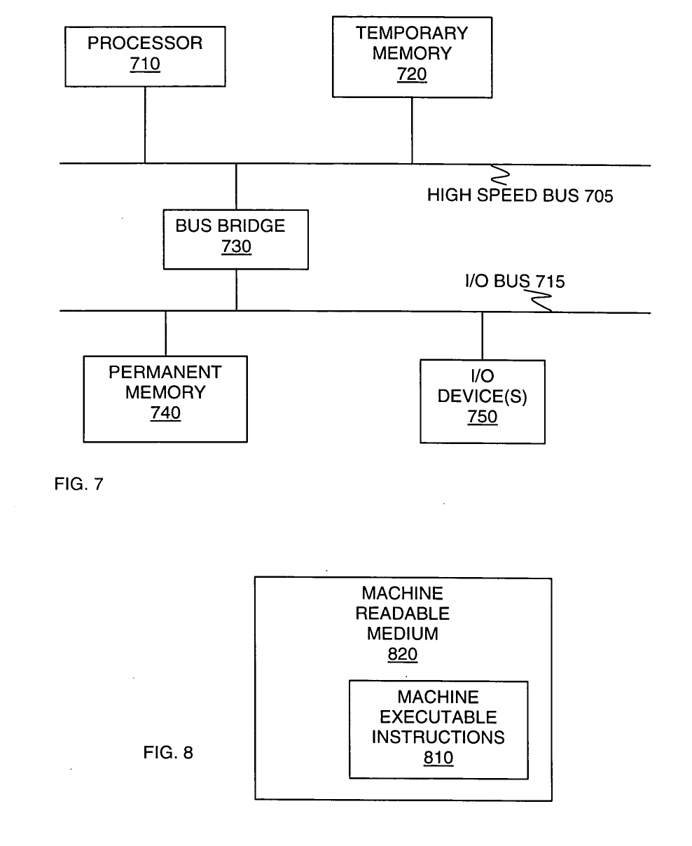

FIG. 7 illustrates one embodiment of a generic hardware system that can bring together the functions of various embodiments of the present invention. In the illustrated embodiment, the hardware system includes processor 710 coupled to high speed bus 705, which is coupled to input/output (I/O) bus 715 through bus bridge 730. Temporary memory 720 is coupled to bus 705. Permanent memory 740 is coupled to bus 715. I/O device(s) 750 is also coupled to bus 715. I/O device(s) 750 may include a display device, a keyboard, one or more external network interfaces, etc.

Certain embodiments may include additional components, may not require all of the above components, or may combine one or more components. For instance, temporary memory 720 may be on-chip with processor 710. Alternately, permanent memory 740 may be eliminated and temporary memory 720 may be replaced with an electrically erasable programmable read only memory (EEPROM), wherein software routines are executed in place from the EEPROM. Some implementations may employ a single bus, to which all of the components are coupled, while other implementations may include one or more additional buses and bus bridges to which various additional components can be coupled. Similarly, a variety of alternate internal networks could be used including, for instance, an internal network based on a high speed system bus with a memory controller hub and an I/O controller hub. Additional components may include additional processors, a CD ROM drive, additional memories, and other peripheral components known in the art.

Various functions of the present invention, as described above, can be implemented using one or more of these hardware systems. In one embodiment, the functions may be implemented as instructions or routines that can be executed by one or more execution units, such as processor 710, within the hardware system(s). As shown in FIG. 8, these machine executable instructions 810 can be stored using any machine readable storage medium 820, including internal memory, such as memories 720 and 740 in FIG. 7, as well as various external or remote memories, such as a hard drive, diskette, CD-ROM, magnetic tape, digital video or versatile disk (DVD), laser disk, Flash memory, a server on a network, etc. These machine executable instructions can also be stored in various propagated signals, such as wireless transmissions from a server to a client. In one implementation, these software routines can be written in the C programming language. It is to be appreciated, however, that these routines may be implemented in any of a wide variety of programming languages.

In alternate embodiments, various functions of the present invention may be implemented in discrete hardware or firmware. For example, one or more application specific integrated circuits (ASICs) could be programmed with one or more of the above described functions. In another example, one or more functions of the present invention could be implemented in one or more ASICs on additional circuit boards and the circuit boards could be inserted into the computer(s) described above. In another example, one or more programmable gate arrays (PGAs) could be used to implement one or more functions of the present invention. In yet another example, a combination of hardware and software could be used to implement one or more functions of the present invention.

Thus, an acoustic sensor with combined frequency ranges is described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

What is claimed is:

1. An apparatus comprising:
a first acoustic sensor to generate a first signal to represent acoustic data in a first bandwidth around a first center frequency;
a second acoustic sensor co-located with the first acoustic sensor to form a hybrid acoustic sensor, said second acoustic sensor to generate a second signal to represent the acoustic data in a second bandwidth around a second center frequency, a lower bound of said first bandwidth being at a lower frequency than a lower bound of said second bandwidth, and a higher bound of said second bandwidth being at a higher frequency than a higher bound of said first bandwidth; and
a mixer to combine the first signal and the second signal into a third signal to represent the acoustic data in a third bandwidth from the lower frequency to the higher frequency.

2. The apparatus of claim 1 wherein:
the first acoustic sensor comprises a circular microphone; and
the second acoustic sensor comprises an annular microphone surrounding the circular microphone.

3. The apparatus of claim 1 wherein the first center frequency comprises 10 KHz, the first bandwidth comprises 20 KHz, the second center frequency comprises 70 KHz, and the second bandwidth comprises 60 KHz.

4. The apparatus of claim 1 further comprising:
an analog-to-digital converter to convert the third signal into a stream of digital data samples.

5. The apparatus of claim 4 further comprising:
a low pass digital filter to receive the stream of digital data samples and pass a lower bandwidth stream of digital data samples; and
a high pass digital filter to receive the stream of digital data samples and pass a higher bandwidth stream of digital data samples.

6. The apparatus of claim 5 wherein the lower bandwidth stream of digital data samples corresponds to the acoustic data in the first bandwidth, and the higher bandwidth stream of digital data samples corresponds to the acoustic data in the second bandwidth.

7. The apparatus of claim 5 further comprising:
an audio tracking unit to receive the lower bandwidth stream of digital data; and
an ultrasonic pen unit to receive the higher bandwidth stream of digital data samples.

8. The apparatus of claim 1 wherein the hybrid acoustic sensor comprises a first hybrid acoustic sensor among an array of hybrid acoustic sensors.

9. The apparatus of claim 1 wherein at least one of the first acoustic sensor and the second acoustic sensor comprise a micro-electrical-mechanical-system (MEMS).

10. A method comprising:
receiving acoustic data at a hybrid acoustic sensor;
generating a first signal to represent the acoustic data in a first bandwidth around a first center frequency;
generating a second signal to represent the acoustic data in a second bandwidth around a second center frequency, a lower bound of said first bandwidth being at a lower frequency than a lower bound of said second bandwidth, and a higher bound of said second bandwidth being at a higher frequency than a higher bound of said first bandwidth; and
combining the first signal and the second signal into a third signal to represent the acoustic data in a third bandwidth from the lower frequency to the higher frequency.

11. The method of claim 10 further comprising:
converting the third signal from an analog form into a stream of digital data samples.

12. The method of claim 11 further comprising:
low pass filtering the stream of digital data samples to pass a lower bandwidth stream of digital data samples; and
high pass filtering the stream of digital data samples to pass a higher bandwidth stream of digital data samples.

13. The method of claim 12 further comprising:
interleaving the higher bandwidth stream of digital data samples with a plurality of additional streams of digital data samples from a plurality of additional hybrid acoustic sensors to create an interleaved stream of data samples; and
supplying the interleaved stream of data samples to an ultrasonic pen unit.

14. The method of claim 12 further comprising:
interleaving the lower bandwidth stream of digital data samples with a plurality of additional streams of digital data samples from a plurality of additional hybrid acoustic sensors to create an interleaved stream of data samples; and
supplying the interleaved stream of data samples to an audio tracking unit.

15. A machine readable medium having stored therein machine executable instructions that, when executed, implement a method comprising:
receiving acoustic data at a hybrid acoustic sensor;
generating a first signal to represent the acoustic data in a first bandwidth around a first center frequency;
generating a second signal to represent the acoustic data in a second bandwidth around a second center frequency, a lower bound of said first bandwidth being at a lower frequency than a lower bound of said second bandwidth, and a higher bound of said second bandwidth being at a higher frequency than a higher bound of said first bandwidth; and
combining the first signal and the second signal into a third signal to represent the acoustic data in a third bandwidth from the lower frequency to the higher frequency.

16. The machine readable medium of claim 15, the method further comprising:
converting the third signal from an analog form into a stream of digital data samples.

17. The machine readable medium of claim 16, the method further comprising:
low pass filtering the stream of digital data samples to pass a lower bandwidth stream of digital data samples; and
high pass filtering the stream of digital data samples to pass a higher bandwidth stream of digital data samples.

18. The machine readable medium of claim 17, the method further comprising:
interleaving the higher bandwidth stream of digital data samples with a plurality of additional streams of digital data samples from a plurality of additional hybrid acoustic sensors to create an interleaved stream of data samples; and
supplying the interleaved stream of data samples to an ultrasonic pen unit.

19. The machine readable medium of claim 17, the method further comprising:
interleaving the lower bandwidth stream of digital data samples with a plurality of additional streams of digital data samples from a plurality of additional hybrid acoustic sensors to create an interleaved stream of data samples; and
supplying the interleaved stream of data samples to an audio tracking unit.

20. A system comprising:
a host device to provide a graphical user interface; and
a client device coupled with the host device, said client device including an array of hybrid acoustic sensors to provide a stream of control data for the graphical user interface, each of the hybrid acoustic sensors comprising
a first acoustic sensor to generate a first signal to represent acoustic data in a first bandwidth around a first center frequency,
a second acoustic sensor co-located with the first acoustic sensor, said second acoustic sensor to generate a second signal to represent the acoustic data in a second bandwidth around a second center frequency, a lower bound of said first bandwidth being at a lower frequency than a lower bound of said second bandwidth, and a higher bound of said second bandwidth being at a higher frequency than a higher bound of said first bandwidth, and
a mixer to combine the first signal and the second signal into a third signal to represent the acoustic data in a third bandwidth from the lower frequency to the higher frequency, said third signal comprising the stream of control data for the graphical user interface.

21. The system of claim 20 wherein each hybrid acoustic sensor further comprises:
an analog-to-digital converter to convert the third signal into a stream of digital data samples.

22. The system of claim 21 wherein each hybrid acoustic sensor further comprises:
a low pass digital filter to receive the stream of digital data samples and pass a lower bandwidth stream of digital data samples; and
a high pass digital filter to receive the stream of digital data samples and pass a higher bandwidth stream of digital data samples.

23. The system of claim 22 wherein the graphical user interface comprises:
an audio tracking unit to receive the lower bandwidth stream of digital data; and
an ultrasonic pen unit to receive the higher bandwidth stream of digital data samples.
